(19) United States
(12) Patent Application Publication
(10) Pub. No.: US 2010/0173655 A1
(43) Pub. Date: Jul. 8, 2010

(54) METHOD OF RECEIVING CONFIRMATION OF A SHORT MESSAGE SERVICE MESSAGE AND TERMINAL APPARATUS FOR PERFORMING THE SAME

(76) Inventors: Sung-Yong Choi, Seoul (KR); Seong-Gyun Kim, Seoul (KR); Chul-Jin Jang, Gyeonggi-do (KR); Man-Hee Jang, Gyeonggi-do (KR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/602,266

(22) PCT Filed: May 30, 2008
(86) PCT No.: PCT/KR08/03050

§ 371 Date: Nov. 30, 2009

(30) Foreign Application Priority Data
May 30, 2007 (KR) 10-2007-0052831

(51) Int. Cl. H04W 4/12

(52) U.S. Cl. 455/466

(57) ABSTRACT

An embodiment provides an electronic card terminal apparatus comprising: a mobile terminal comprising a card socket; and an electronic card coupled to the card socket, the electronic card comprising: a connector comprising a plurality of terminals connected to the card socket; at least one wireless short distance communication module electrically connected to the connector and performing wireless short distance communication through a predetermined frequency band; a card module storing user information and electrically connected to the connector and the wireless short distance communication module; and an antenna transmitting/receiving data of the wireless short distance communication module.

### TECHNICAL FIELD

The present invention relates to a method for confirming a short message service (SMS) message and a terminal apparatus for performing the method, and more particularly, to a method for confirming an SMS message by using a virtual machine (VM) and a terminal apparatus for performing the method.

### BACKGROUND ART

Generally, a short message service (SMS) message in a code division multiple access (CDMA) system is easily realized by its inherent data transmission function in the CDMA communication system.

The SMS message has a two-way paging function, and thus enables various services such as a text message receiving service, voicemail notification, a text message transmitting service, etc. In the SMS, a mobile communication system and a mobile communication terminal communicate with each other by using a data burst message defined in the IS-95-A standard. The data burst message, however, is considerably restricted in its length. Specifically, the length of a receiving data burst message is limited to about 150 bytes, and the length of a transmitting data burst message is limited to about 100 bytes.

The SMS may be classified as a mobile terminated (MT) SMS for receiving messages, a mobile originated (MO) SMS for transmitting messages, a broadcast-type information service similar to wireless paging, an information-on-demand service using bidirectional communication characteristics. Alternatively, the SMS may be used for various remote control services.

Recently, as the supply rate of mobile phones has been increased, the SMS message service has become widely used. When a transmitting mobile phone transmits an SMS message to a receiving mobile phone via a mobile communication network system, the SMS message service is realized. The above process is only used to inform that the SMS message of the transmitting side is normally received by a short message service center (SMSC) server of a mobile communication network system which manages an SMS service, and a transmitting process of an SMS message is ended when the corresponding SMS message is transmitted.

Thus, the transmitting side cannot check whether or not the receiving side has read the SMS message, so that accuracy for a communication delivery between the transmitting side and the receiving side may be lowered. Thus, this may cause a problem when the transmitting side transmits an important SMS message.

### DISCLOSURE OF THE INVENTION

### Technical Problem

The present invention provides a method for confirming a short message service (SMS) message using a virtual machine (VM), by providing a transmitting side with information as to whether or not a receiving side has checked the SMS message transmitted by a transmitting side, to provide user convenience.

The present invention also provides a terminal apparatus for performing the above-mentioned method for confirming an SMS message using the VM.

### Technical Solution

According to a first embodiment of the present invention, in a method for confirming an SMS reading confirmation, which confirms whether or not the SMS message provided from a transmitting mobile phone has been read at a receiving mobile phone, the method comprises: transmitting an SMS message and storing the transmitted SMS message in an outbox of the transmitting mobile phone; when the transmitting mobile phone is subscribed to a reading confirmation service and the reading confirmation message has been received, displaying the received reading confirmation message on a display window of the transmitting mobile phone to compare with the SMS message stored in the outbox and the reading confirmation message; and when the SMS message is in the outbox, displaying the corresponding SMS message as a reading confirmation.

In an example embodiment of the present invention, the reading confirmation message may include brief information.

In an example embodiment of the present invention, the reading confirmation message may be detailed information including the transmitted SMS message.

According to a second embodiment of the present invention, in a method for confirming an SMS reading confirmation, which confirms whether or not the SMS message provided from a transmitting mobile phone has been read at a receiving mobile phone, the method comprises: transmitting an SMS message and storing the transmitted SMS message in an outbox of the transmitting mobile phone; when the transmitting mobile phone is subscribed to a reading confirmation service and the reading confirmation message has been received, displaying the received reading confirmation message on a display window of the transmitting mobile phone, and storing the reading confirmation message in an inbox of the transmitting mobile phone; comparing an SMS message stored in the outbox thereof and an SMS message stored in the inbox thereof by executing a VM; when a matching SMS message is in the outbox, displaying the corresponding SMS message as a reading confirmation message; and as the reading confirmation message has been selected by a user, displaying a detailed message of the corresponding message.

According to a third embodiment of the present invention, in a method for confirming an SMS reading confirmation, which confirms whether or not the SMS message provided from a transmitting mobile phone has been read at a receiving mobile phone, the method comprises: transmitting an SMS message and storing the transmitted SMS message in an outbox of the transmitting mobile phone; when the transmitting mobile phone is subscribed to a reading confirmation service and the reading confirmation message has been received, displaying the received reading confirmation message on a display window of the transmitting mobile phone, and storing the reading confirmation message in a receiving confirmation box of the transmitting mobile phone; comparing an SMS message stored in the outbox thereof and an SMS message stored in the receiving confirmation box included in a VM by executing the VM; when a matching SMS message is in the outbox, displaying the corresponding SMS message as a reading confirmation message; and as the reading confirmation message has been selected by a user, displaying a detailed message of the corresponding message.

According to a fourth embodiment of the present invention, in a method for confirming an SMS reading confirmation, which confirms whether or not the SMS message provided from a transmitting mobile phone has been read at a receiving mobile phone, the method comprises: transmitting an SMS message and storing the transmitted SMS message in an outbox of the transmitting mobile phone; when the transmitting mobile phone is subscribed to a reading confirmation service and the reading confirmation message has been received, displaying the received reading confirmation message on a display window of the transmitting mobile phone, and storing text in an inbox of the transmitting mobile phone to display the text, wherein the text confirms whether or not the reading confirmation message has been received; as the text is selected by a user, executing a VM to store a reading confirmation message in a receiving confirmation box of the VM; comparing an SMS message stored in the outbox of the transmitting mobile phone and an SMS message stored in the receiving confirmation box of the VM through the VM; when a matching SMS message is in the outbox, displaying the corresponding SMS message as a reading confirmation message; and as the reading confirmation message has been selected by a user, displaying a detailed message of the corresponding message.

According to a fifth embodiment of the present invention, in a method for confirming an SMS reading confirmation, which confirms whether or not the SMS message provided from a transmitting mobile phone has been read at a receiving mobile phone, the method comprises: transmitting an SMS message and storing the transmitted SMS message in an outbox of the transmitting mobile phone; when the transmitting mobile phone is subscribed to a reading confirmation service and the reading confirmation message has been received, displaying the received reading confirmation message on a display window of the transmitting mobile phone, and storing text in an inbox of the transmitting mobile phone to display the text, wherein the text confirms whether or not the reading confirmation message has been received; storing a reading confirmation message in a receiving confirmation box of a VM, and comparing an SMS message stored in the outbox of the transmitting mobile phone and an SMS message stored in the receiving confirmation box of the VM through the VM; when a matching SMS message is in the outbox, checking whether or not a program is selected by a user, wherein the program confirming whether or not a reading confirmation message has been received; when the program for confirming whether or not the reading confirmation message has been received, displaying a list of a receiving confirmation box of the VM, and checking whether or not a predetermined message is selected by a user; and when the predetermined message is selected by a user, displaying a detailed message of the corresponding message.

According to a sixth embodiment of the present invention, in a method for confirming an SMS reading confirmation, which confirms whether or not the SMS message provided from a transmitting mobile phone has been read at a receiving mobile phone, the method comprises: transmitting an SMS message and storing the transmitted SMS message in an outbox of the transmitting mobile phone; when the transmitting mobile phone is subscribed to a reading confirmation service and the reading confirmation message has been received, displaying the received reading confirmation message on a display window of the transmitting mobile phone, and executing a VM included in the transmitting mobile phone to store the reading confirmation message in a receiving confirmation box of the VM; and displaying a detailed message of the corresponding message stored in the receiving confirmation box of the VM.

According to an embodiment of the present invention, a reading confirmation terminal apparatus for confirming a reading of an SMS message by using an SMS message includes a display part, a wireless circuit part and a control part. The wireless circuit part sets a communication channel with a mobile communication network system. The control part transmits an SMS message composed by a user, and stores the transmitted SMS message in an outbox thereof. When the transmitting mobile phone is subscribed to a reading confirmation service and the reading confirmation message has been received, the control part compares the SMS message stored in an outbox thereof and the reading confirmation message by using a VM to provide the display part with the comparison result so as to recognize a user. When the reading confirmation message has been received, the control part displays the reading confirmation message on the display part.

### ADVANTAGEOUS EFFECTS

According to a method for confirming an SMS message and a terminal apparatus for performing the method, an SMS message stored in an outbox and a reading confirmation message stored in an inbox or a VM are compared with each other to display the comparison result so as to recognize a user by using the VM of the terminal apparatus, so that usability of an SMS message may be provided to the SMS message transmitting side when a reading confirmation service of an SMS message is performed.

### BRIEF DESCRIPTION OF THE DRAWINGS

The above and other advantages of the present invention will become more apparent by describing in detail example embodiments thereof with reference to the accompanying drawings, in which:

FIG. 1 is a schematic diagram illustrating a service system performing a function of a reading confirmation service of a short message service (SMS) message according to an embodiment of the present invention.

FIG. 2 is a block diagram illustrating a mobile phone having a function of a reading confirmation service of an SMS message by using an SMS message according to the present invention.

FIG. 3 is a data packet diagram illustrating a message structure of each layer of the IS-637 standard.

FIG. 4 is a flowchart schematically illustrating a method of a reading confirmation service of an SMS message according to an embodiment of the present invention. Particularly, a reading confirmation function through a comparison with an outbox of a mobile phone and an inbox of the mobile phone is shown.

FIG. 5 is an image showing examples of a mobile phone screen in accordance with a reading confirmation service of an SMS message as shown in FIG. 4.

FIG. 6 is a flowchart schematically illustrating a method of a reading confirmation service of an SMS message according to a second embodiment of the present invention. Particularly, a reading confirmation function through a comparison with an outbox of a mobile phone and a receiving confirmation box of the mobile phone is shown.

FIG. 7 is a flowchart schematically illustrating a method of a reading confirmation service of an SMS message according to a third embodiment of the present invention.

FIG. 8 is an image showing examples of a mobile phone screen in accordance with a reading confirmation service of an SMS message as shown in FIG. 7.

FIG. 9 is a flowchart schematically illustrating a method of a reading confirmation service of an SMS message according to a fourth embodiment of the present invention.

FIG. 10 is an image showing examples of a mobile phone screen in accordance with a reading confirmation service of an SMS message as shown in FIG. 9.

FIG. 11 is a flowchart schematically illustrating a method of a reading confirmation service of an SMS message according to a fifth embodiment of the present invention.

FIG. 12 is an image showing examples of a mobile phone screen in accordance with a reading confirmation service of an SMS message as shown in FIG. 11.

FIG. 13 is a flowchart schematically illustrating a method of a reading confirmation service of an SMS message according to a sixth embodiment of the present invention.

FIG. 14 is an image showing examples of a mobile phone screen in accordance with a reading confirmation service of an SMS message as shown in FIG. 13.

FIG. 15 is a flowchart schematically illustrating a method of a reading confirmation service of an SMS message according to a seventh embodiment of the present invention.

FIG. 16 is an image showing examples of a mobile phone screen in accordance with a reading confirmation service of an SMS message as shown in FIG. 15.

### BEST MODE FOR CARRYING OUT THE INVENTION

It should be understood that the example embodiments of the present invention described below may be varied modified in many different ways without departing from the inventive principles disclosed herein, and the scope of the present invention is therefore not limited to these particular following embodiments. Rather, these embodiments are provided so that this disclosure will be through and complete, and will fully convey the concept of the invention to those skilled in the art by way of example and not of limitation.

Hereinafter, the present invention will be described in detail with reference to the accompanying drawings.

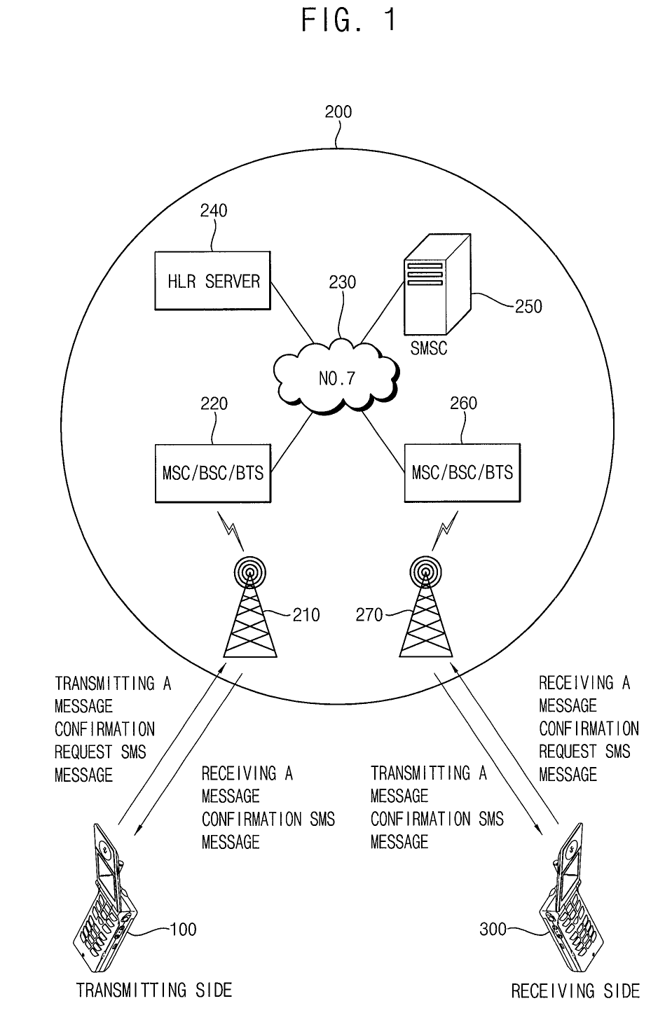

FIG. 1 is a schematic diagram illustrating a service system performing a function of a reading confirmation service of a short message service (SMS) message according to an embodiment of the present invention.

Referring to FIGS. 1 to 4, in order to realize a service system of a reading confirmation of an SMS message by using an SMS message, the service system according to an embodiment of the present invention includes a transmitting mobile phone 100, a mobile communication network system 200 and a receiving mobile phone 300. In this embodiment, for ease of description, a side firstly transmitting an SMS message is defined as a transmitting side, and an action transmitting an SMS message by the transmitting side is defined as a transmission. Moreover, a side receiving the SMS message is defined as a receiving side, and an action receiving an SMS message by the receiving side is defined as a receipt.

The transmitting mobile phone 100 provides the receiving mobile phone 300 with a message confirmation request SMS message via the mobile communication network system 200. The transmitting mobile phone 100 receives a message confirmation SMS message that is delivered when the receiving mobile phone 300 receives a message confirmation request SMS message, and checks the SMS message stored in an outbox as a reading confirmation. The reading confirmation may be processed such as a check box image, an underline, an open-envelope image, etc. For example, the message confirmation request SMS message is included in the composed SMS message to be transmitted.

The mobile communication network system 200 includes a transmitting base station 210, a transmitting exchange 220, a No. 7 mobile communication network 230, a home location register (HLR) server 240, a short message service center (SMSC) server 250, a receiving exchange 260 and a receiving base station 270, and sets a communication channel between the transmitting mobile phone 100 and the receiving mobile phone 300. The transmitting exchange 220 includes a mobile switching center (MSC), a base station controller (BSC) and a base transceiver station (BTC).

The HLR server 240 manages subscriber data of a reading confirmation of an SMS message by using an SMS message and information such as a location, a possibility of receiving, an additional service, etc., for a receiving mobile phone. For example, the HLR server 240 may search for the location of the receiving mobile phone when information requesting a location confirmation of a reader is included in the SMS message, and may provide the SMSC server 250 with the searched location of the reader.

The receiving mobile phone 300 stores the message confirmation request SMS message through the mobile communication network system 200, and provides the message confirmation SMS message to the transmitting mobile phone 100 when the stored message confirmation request SMS message is confirmed by a user.

The transmitting mobile phone 100 and the receiving mobile phone 300 according to the present invention may commonly load software that is programmed to perform the following functions. That is, software is commonly loaded in the receiving and transmitting mobile phones 100 and 300, which is programmed to perform a method of reading confirmation of an SMS message by using an SMS message which confirms whether or not the SMS message transmitted by the transmitting mobile phone has been read in a receiving mobile phone. Here, the SMS message includes a teleservice identification (TID) for using an SMS push message to be used for identifying an ID for a reading confirmation.

For example, the transmitting mobile phone loads the software program which loads a process storing the transmitted SMS message in an outbox thereof, a process comparing the SMS message stored in the outbox and the SMS message stored in the inbox when the transmitting mobile phone is subscribed to a reading confirmation service and the reading confirmation message has been received, and a process displaying the corresponding SMS message as the reading confirmation when a matching SMS message is in the outbox. Additionally, when the matching SMS message is in the inbox at the comparing process, the software program may further load a process removing the corresponding SMS message.

FIG. 2 is a block diagram illustrating a mobile phone having a function of a reading confirmation service of an SMS message according to the present invention.

Referring to FIG. 2, a mobile phone 100 having a service function of a reading confirmation of an SMS message by using an SMS message includes a control part 110, a keypad 120, a display part 130, a memory part 140, an audio processing part 150 and a wireless circuit part 160.

The control part 110 controls whole function of a mobile phone through receiving or transmitting signals with elements such as the keypad 120, the display part 130, the memory part 140, the audio processing part 150 and the wireless circuit part 160.

As the message confirmation request SMS message is composed by a user in an SMS message transmitting mode, the control part 110 stores the composed message confirmation request SMS message in the outbox, and controls to be provided the mobile communication network system by using a communication channel that is set by the wireless circuit part 160. For example, the outbox may be stored in the memory part 140.

For example, as the message confirmation request SMS message is received, the control part 110 compares the message confirmation SMS message delivered through the mobile communication network system and the various message confirmation request SMS messages stored in the mobile phone, and controls that the stored corresponding message confirmation request SMS message is checked as a reading confirmation. Here, the comparing process between the message confirmation SMS message and the message confirmation request SMS messages may be performed by using a virtual machine (VM). The VM is a so-called application program which is driven by an operating system (OS) for a mobile phone. In the comparing process, the compared list may include a transmitting mobile phone number, a receiving mobile phone number, a transmitting-receiving time, etc., that are displayed in the SMS message.

The message confirmation request SMS message may be stored in an outbox of a mobile phone. Alternatively, the message confirmation request SMS message may be stored in an inbox of the mobile phone or a receiving confirmation box of the VM.

Moreover, when the message confirmation SMS message is received from the receiving side, the control part 110 displays the received message confirmation SMS message on the display part 130. Thus, the transmitting side transmitting an SMS message may confirm that the SMS message has been read at the transmitting side. The message confirmation SMS message displayed on the display part 130 may include brief information of the message confirmation SMS message or detailed information of the message confirmation SMS message. For example, the brief information of the message confirmation SMS message may include a phone number of the receiving side and a reading time. The detailed information of the message confirmation SMS message may include a phone number of the receiving side, a reading time, contents of the message, etc.

In the SMS message receiving mode, the control part 110 controls that the message confirmation request SMS message provided from a transmitting side by using a communication channel that is set with the communication network system is stored in an inbox, and the receiver side is alerted to the stored message confirmation request SMS message. For example, the inbox may be stored in the memory part 140.

As the stored message confirmation request SMS message is confirmed by a user, the control part 110 controls the message confirmation SMS message to be transmitted to the transmitting side via the mobile communication network system.

The keypad 130 includes a functional button for performing a function and a general button for inputting letters and numbers as an inputting means transmitting a command of a user, and performs a function of transmitting a command of a user to the control part 110.

The display part 130 may display an information screen displaying information of a mobile phone, a menu screen displaying various functions, an input screen for inputting letters and numbers, a result screen displaying the result of the function, etc., in accordance with a control of the control part 110. Thus, a mobile phone user views the screens and selects a desired function.

The memory part 140 loads a program which drives a function that is processed by the control part 110, a program which realizes convenient and various functions for a user, etc. The memory part 140 generally includes a flash memory, a random access memory (RAM) and a read-only memory (ROM).

The flash memory loads a real time operating system (OS) and calls processing software of a mobile phone, and read variable factors and status of the programs from the RAM to operate the real time operating system (OS) and the calls processing software. The ROM may include an electrically erasable programmable read-only memory (EEPROM), and stores nonvolatile data which can be erasable and rewritten to perform input/output according to a command of the control part 100. The ROM may store a number assignment module (NAM) parameter, data for storing (i.e., a phone number and a name, a text message, a moving image and so on), etc.

Moreover, the flash memory is a nonvolatile memory having a high processing speed and keeping data. When a mobile phone is upgraded, the flash memory may load upgraded software. For example, the flash memory loads a program that performs a function of adding a message confirmation request to a transmitting message, and a function of transmitting a message confirmation SMS message to a transmitting mobile phone when the receiving user reads the SMS message.

Additionally, the memory part 140 may store a received text message, system information for managing the mobile phone, etc. For example, the memory part 140 includes a first area that is set as an outbox and a second area that is set as an inbox. The first area may store the transmitted SMS messages, and the second area may store the receiving SMS message and a reading confirmation SMS message corresponding to own transmitted SMS message. As a memory capacity is considered, the reading confirmation SMS message may be removed in accordance with a user's selection and may be automatically removed when the transmitted SMS message that is stored in the outbox is displayed as a reading confirmation.

Moreover, the memory part 140 may include a third area that is set as a receiving confirmation box of a VM. The third area may temporarily store a plurality of reading confirmation messages corresponding to a transmitted SMS message.

The audio processing part 150 converts, for example, analog-type audio recorded through a microphone of a mobile phone into digital-type audio to transmit the digital audio to the control part 110. Alternatively, the audio processing part 150 processes data received from the exterior to output an analog type audio through a speaker (SPK).

The wireless circuit part 160 is set a communication channel with a mobile communication network system to receive at least one of calls, text messages and audio data through an antenna (ANT) and transmits the calls, the text messages and the audio data to the control part 110. Moreover, the wireless circuit part 160 may perform a role of transmitting data that is stored in the memory part 140 to a transmitting telephone through the antenna (ANT).

As described above, a mobile phone according to the present invention loads a program that performs a function of adding a message confirmation request to a transmitting message by a transmitting side, and a function of transmitting a message confirmation SMS message to a transmitting mobile phone when the receiving user reads the SMS message received from the transmitting side, so that accuracy for a communication delivery between the transmitting side and the receiving side may be achieved.

In FIG. 2, when the message confirmation SMS message is received at the receiving side, the control part 110 displays the received message confirmation SMS message on the display part 130. Alternatively, when the message confirmation SMS message is received, an additional audio alarm may be performed.

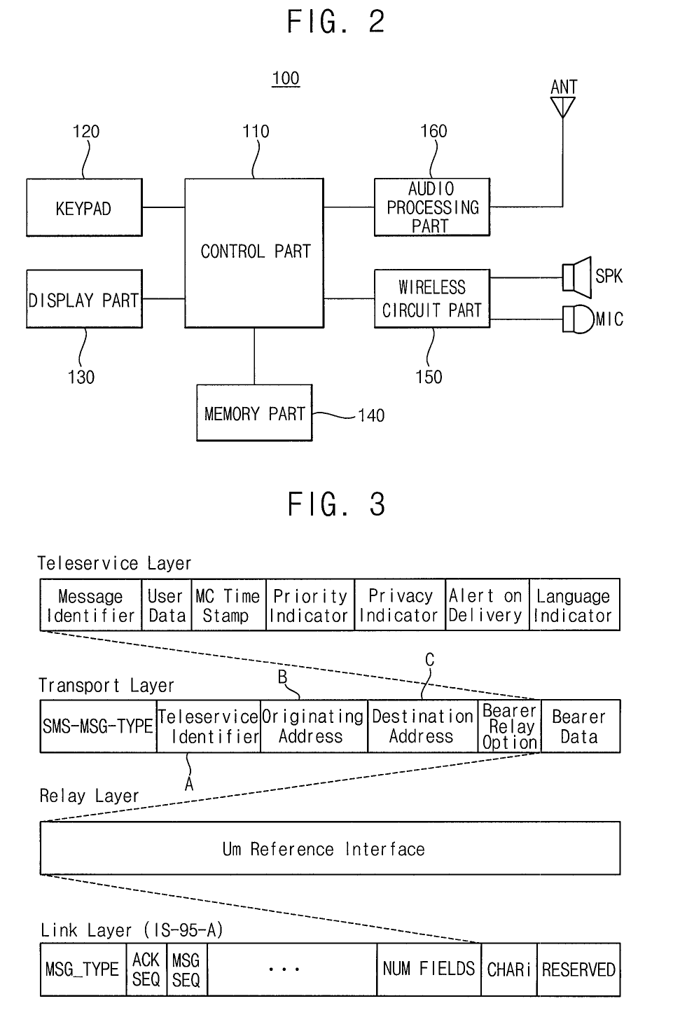

A layer structure for identification of an SMS message will be described with reference to FIG. 3.

FIG. 3 is a data packet diagram illustrating a message structure of each layer of the IS-637 standard.

Referring to FIG. 3, a CHARi message of a data burst message (or a link layer) includes an SMS parameter that is encapsulated, and the CHARi message is analyzed to be transmitted to an upper layer.

A transport layer is set through a Um interface of a relay layer based on data burst message of IS-95-A standard performing a role of a link layer. The transport layer includes a teleservice identifier ‘A’ that is a service identifier for services such as voicemail and general messages, a transmitting side originating address ‘B’, a receiving side destination address ‘C’, a bearer reply option and bearer data. The bearer data may form a teleservice layer.

The teleservice layer includes a message identifier, a user data having a receiving contents, a message center time stamp (MC time stamp) for the corresponding message, a priority indicator, a privacy indicator, a message alert on delivery and a language indicator to provide an application service.

A formation of a message identifier included in the teleservice layer is described in the following Table 1.

TABLE 1

| Field | Length (bits) |
|---|---|
| SUBPARAMETER_ID | 8 |
| SUBPARAM_LEN | 8 |
| MESSAGE_TYPE | 4 |
| MESSAGE_ID | 16 |
| RESERVED | 4 |

Referring to Table 1, the “SUBPARAMETER_ID” field having an eight-bit length is a field for identifying a message identifier. The “SUBPARAM_LEN” field having an eight-bit length is a field that stores the length data of the following message. The “MESSAGE_TYPE” field having a four-bit length is a field for identifying one of five types whether the corresponding message is a deliver message, the corresponding message is a submit message, etc. The “MESSAGE_ID” field having a sixteen-bit length is a field for identifying a message at a teleservice end point outputting a message.

A predetermined value capable of identifying by a transmitting side is set in the SUBPARAMETER_ID value set as 8 bits (i.e., 00000000), so that the reading confirmation service of an SMS message by using a VM according to the present invention may be performed.

For example, as a user using a mobile phone is subscribed to the reading position and reading time service, the SUBPARAMETER_ID value is set from <00000000> to <11111111>. Then, the mobile communication network system identifies the SUBPARAMETER_ID value set as <11111111>, so that the reading confirmation service of an SMS message by using a VM according to the present invention may be processed.

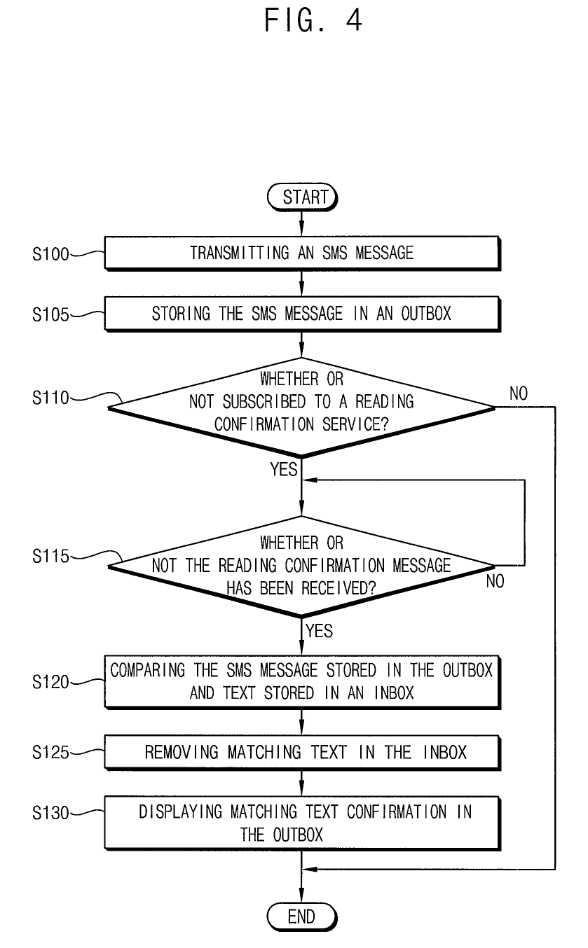

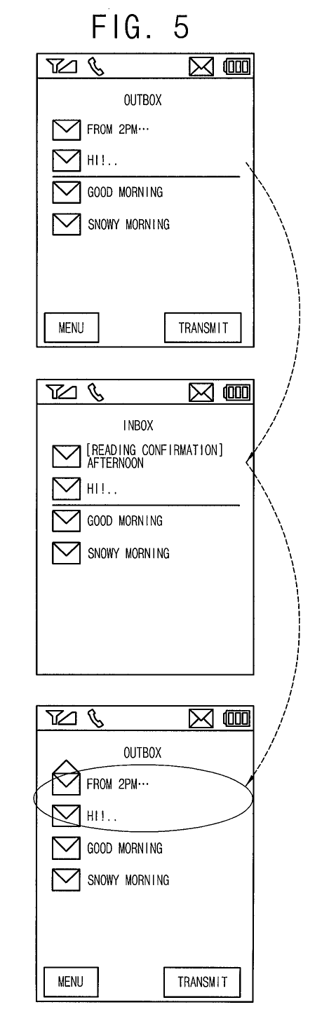

FIG. 4 is a flowchart schematically illustrating a method of a reading confirmation service of an SMS message according to an embodiment of the present invention. FIG. 5 is an image showing examples of a mobile phone screen in accordance with a reading confirmation service of an SMS message as shown in FIG. 4. Particularly, a reading confirmation function through a comparison with an outbox of a mobile phone and an inbox of the mobile phone is shown.

Referring to FIGS. 4 and 5, an SMS message that is composed through a transmitting mobile phone of a user is transmitted to a receiving mobile phone via a mobile communication network system (step S100).

Then, the transmitted SMS message is stored in an outbox of the transmitting mobile phone (step S105).

Then, the transmitting mobile phone 100 checks itself as to whether it is subscribed to the SMS message reading confirmation service by using a VM or not (step S110).

In step S110, the checking process is ended when it is not checked that the transmitting mobile phone 100 is subscribed to the reading confirmation service, and it is checked whether the reading confirmation message is received when it is checked that the transmitting mobile phone 100 is subscribed to the reading confirmation service (step S115). The reading confirmation message may include information that the corresponding SMS message has been read by a user of the receiving mobile phone in addition to information that the SMS message has been normally received at the receiving mobile phone.

When it is checked that the reading confirmation message has been received, at least one of SMS messages stored in an outbox of the transmitting mobile phone and text stored in an inbox of the transmitting mobile phone are compared with each other (step S120). Here, a list that is compared with each other may be text stored in each messages, numbers stored in the outbox and the inbox. For example, a phone number of a transmitting side, a phone number of a receiving side, a transmitting time of an SMS message, transmitted contents, etc., may be compared with each other.

Then, matching text is removed from the inbox (step S125). In step S125, the removing of the matching text may be automatically performed or manually performed by a user operation.

Then, a matching SMS message that is stored in the outbox of the transmitting mobile phone is displayed as a text confirmation, that is, a reading confirmation (step S130). In FIG. 4, the step of displaying a reading confirmation is performed after the step of removing the text. Alternatively, the step of removing the text may be performed after the step of displaying the reading confirmation.

In FIG. 4, when it is checked that the reading confirmation message has been received in step S115, step S120, which compares at least one of SMS messages stored in the outbox and the text stored in the inbox, is performed. In addition, the reading confirmation may be displayed on a display part of the transmitting mobile phone to immediately recognize a user. Here, the reading confirmation message displayed on the display part may include brief information or detailed information. For example, the brief information may include a phone number of the receiving side and a reading time. The detailed information may include a phone number of the receiving side, a reading time, contents of the message, etc., in addition to the brief information.

As described above, in Embodiment 1 of the present invention, a plurality of SMS messages that are transmitted is stored in an outbox of a transmitting mobile phone, and a reading confirmation message provided from a receiving side receiving the corresponding SMS message is stored in an inbox of the transmitting mobile phone. Then, a VM checks whether or not the reading confirmation message stored in the inbox of the transmitting mobile phone is in the outbox thereof. When the corresponding reading confirmation message is in the outbox thereof, the predetermined SMS message stored in the outbox thereof is displayed as a reading confirmation.

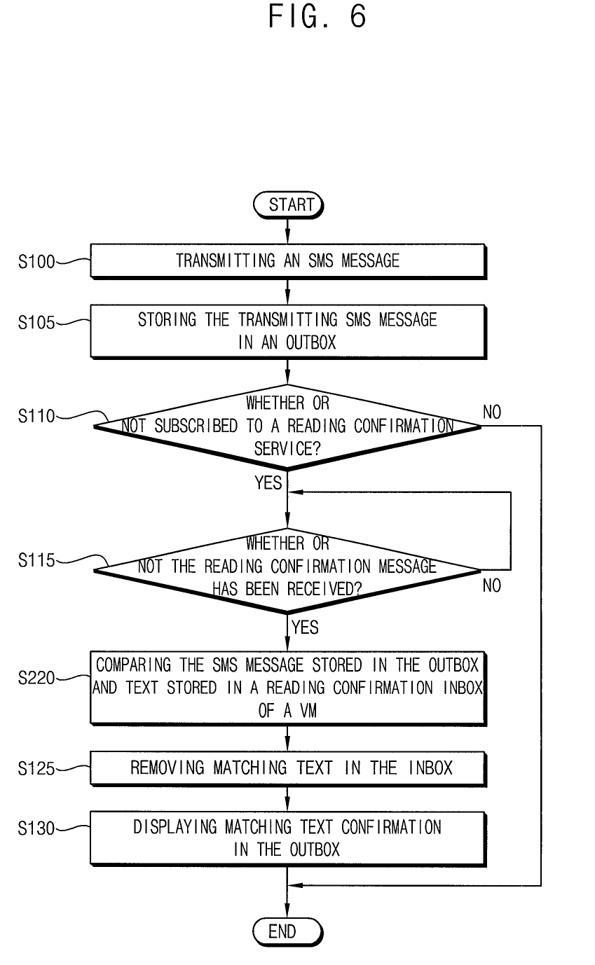

FIG. 6 is a flowchart schematically illustrating a method of a reading confirmation service of an SMS message according to a second embodiment of the present invention. Particularly, a reading confirmation function through a comparison with an outbox of a mobile phone and a receiving confirmation box of the mobile phone is shown.

The flowchart described in FIG. 6 is substantially the same as the flowchart described in FIG. 4 except for at least step S120, thus a detailed description thereof will be omitted.

Referring to FIG. 6, it is checked that the reading confirmation message has been received in step S115, at least one of SMS messages stored in the outbox of the transmitting mobile phone and text stored in a receiving confirmation box included in the transmitting mobile phone are compared with each other (step S220), and then step S125 is performed. Here, a comparing condition may realized by using text or numbers corresponding to the each message. For example, a phone number of a transmitting side, a phone number of a receiving side, a transmitting time of an SMS message, transmitted contents, etc., may be compared with each other. In FIG. 6, when it is checked that the reading confirmation message has been received, step S220, which compares at least one of SMS messages stored in the outbox of the transmitting mobile phone and the text stored in the inbox of the transmitting mobile phone, is performed. In addition, the reading confirmation may be displayed on a display part of the transmitting mobile phone to immediately recognize a user. Here, the reading confirmation message displayed on the display part may include brief information or detailed information. For example, the brief information may include a phone number of the receiving side and a reading time. The detailed information may include a phone number of the receiving side, a reading time, contents of the message, etc., in addition to the brief information.

As described above, in Embodiment 2 of the present invention, a plurality of SMS messages that are transmitted is stored in an outbox of a transmitting mobile phone, and a reading confirmation message provided from a receiving side receiving the corresponding SMS message is temporarily stored in a receiving confirmation box included in the VM of the transmitting mobile phone. Then, the VM checks whether or not the reading confirmation message temporarily stored in the receiving confirmation box of the transmitting mobile phone is in the outbox of the transmitting mobile phone. When the corresponding reading confirmation message is in the outbox of the transmitting mobile phone, the predetermined SMS message stored in the outbox of the transmitting mobile phone is displayed as a reading confirmation.

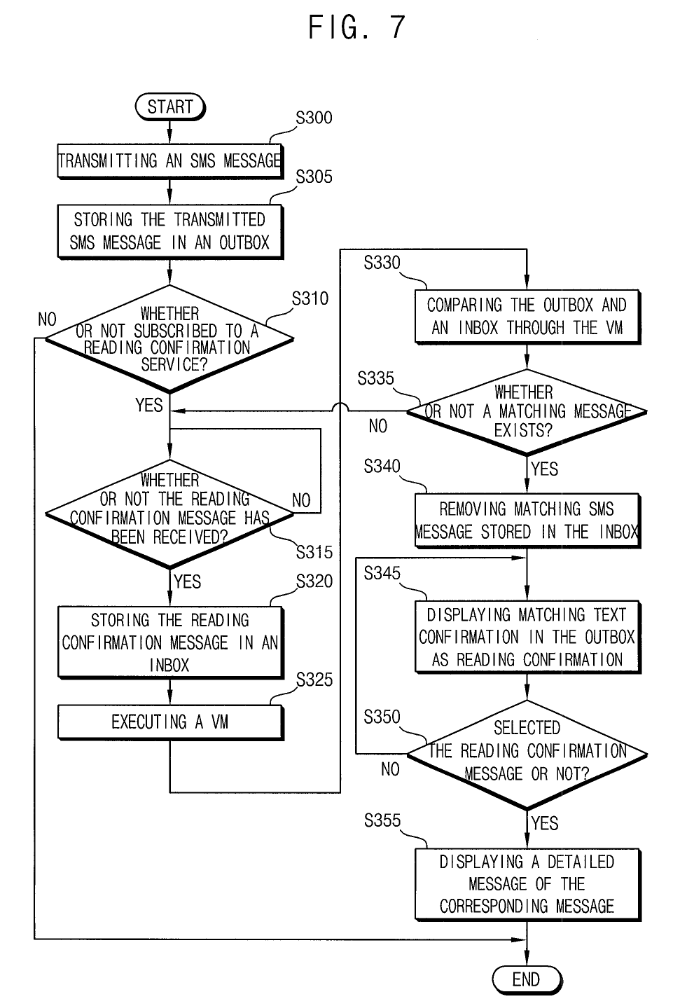

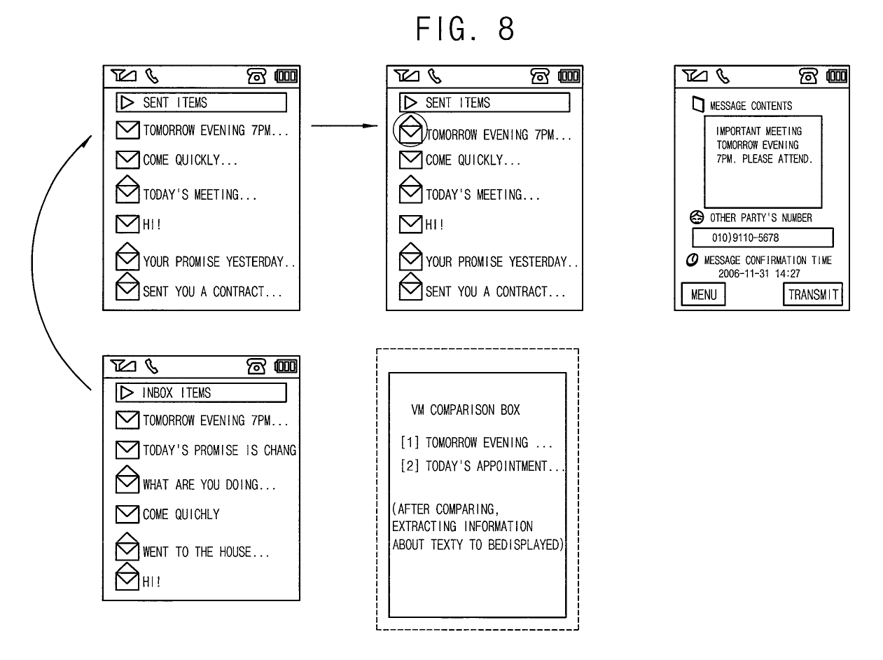

FIG. 7 is a flowchart schematically illustrating a method of a reading confirmation service of an SMS message according to a third embodiment of the present invention. FIG. 8 is an image showing examples of a mobile phone screen in accordance with a reading confirmation service of an SMS message as shown in FIG. 7. In FIG. 8, a dotted-line block is referred to as a receiving confirmation box of a VM. The receiving confirmation box is not displayed at a user side.

Referring to FIGS. 7 and 8, an SMS message that is composed through a transmitting mobile phone of a user is transmitted to a receiving mobile phone via a mobile communication network system (step S300).

Then, the transmitted SMS message is stored in an outbox of the transmitting mobile phone (step S305).

Then, the transmitting mobile phone checks itself as to whether it is subscribed to the SMS message reading confirmation service by using a VM or not (step S310).

In step S310, the checking process is ended when it is not checked that the transmitting mobile phone 100 is subscribed to the reading confirmation service, and it is checked whether the reading confirmation message is received when it is checked that the transmitting mobile phone 100 is subscribed to the reading confirmation service (step S315). The reading confirmation message may include information that the corresponding SMS message has been read by a user of the receiving mobile phone in addition to information that the SMS message has been normally received at the receiving mobile phone.

Then, a reading confirmation message is stored in an inbox of the transmitting mobile phone (step S320).

Then, a VM is executed (step S325).

Then, an outbox of the transmitting mobile phone and an inbox of the transmitting mobile phone are compared with each other by VM (step S330).

Then, the transmitting mobile phone 100 checks whether a matching SMS message or not (step S335), the process is fed back to step S315 when the matching SMS message does not exist.

In step S335, when the matching SMS message exists, the matching SMS message stored in the inbox of the transmitting mobile phone is removed (step S340). In step S340, the removing of the matching SMS message may be automatically performed or manually performed by a user operation.

Then, a matching SMS message that is stored in the outbox of the transmitting mobile phone is displayed as a text confirmation, that is, a reading confirmation (step S345). In FIG. 7, the step of displaying a reading confirmation is performed after the step of removing the text. Alternatively, the step of removing the text may be performed after the step of displaying the reading confirmation.

Then, it is checked whether or not a reading confirmation message is selected by a user (step S335). In step S335, the process is fed back to step S345 when the reading confirmation message is not selected by a user, and a detailed message corresponding to the corresponding message is displayed on a display part when the reading confirmation message is selected by a user.

In FIG. 7, when it is checked that the reading confirmation message has been received in step S315, step S320, which stores the reading confirmation messages in the outbox of the transmitting mobile phone, is performed. In addition, the reading confirmation may be displayed on a display part of the transmitting mobile phone to immediately recognize a user. Here, the reading confirmation message displayed on the display part may include brief information or detailed information. For example, the brief information may include a phone number of the receiving side and a reading time. The detailed information may include a phone number of the receiving side, a reading time, contents of the message, etc., in addition to the brief information.

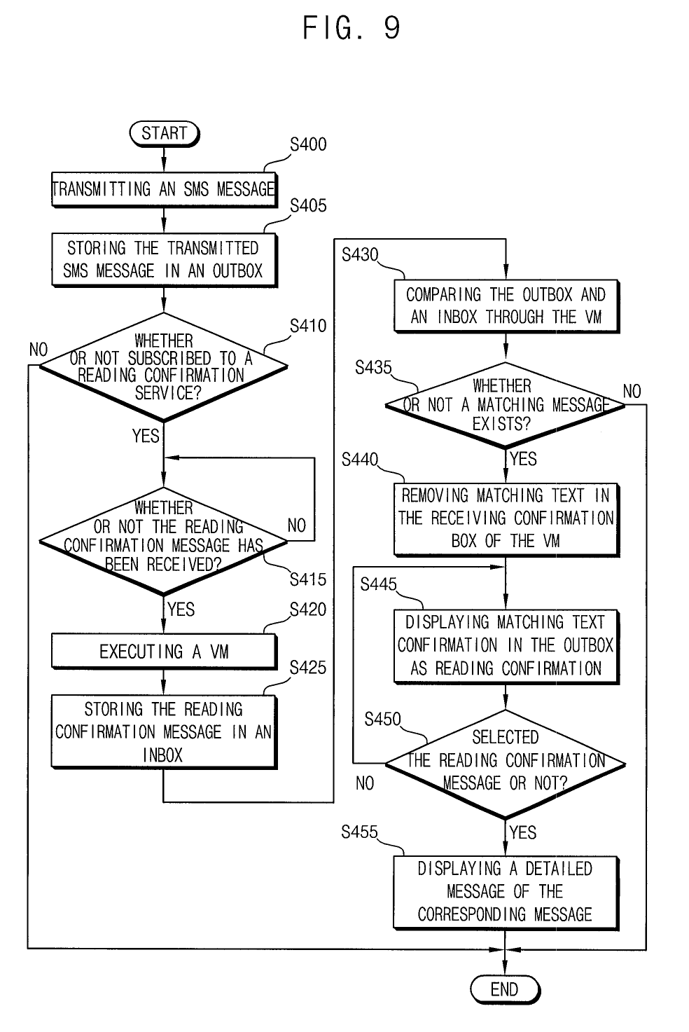

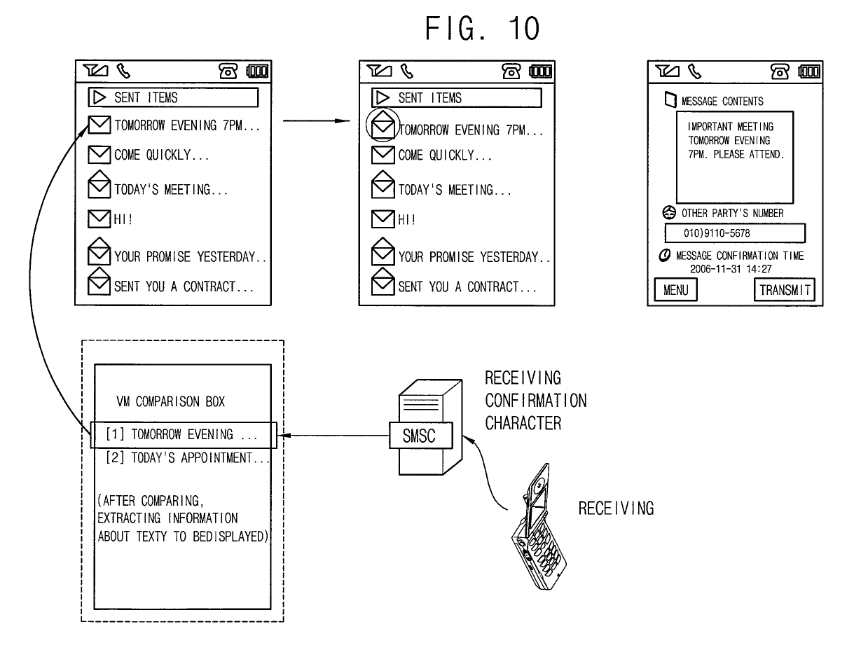

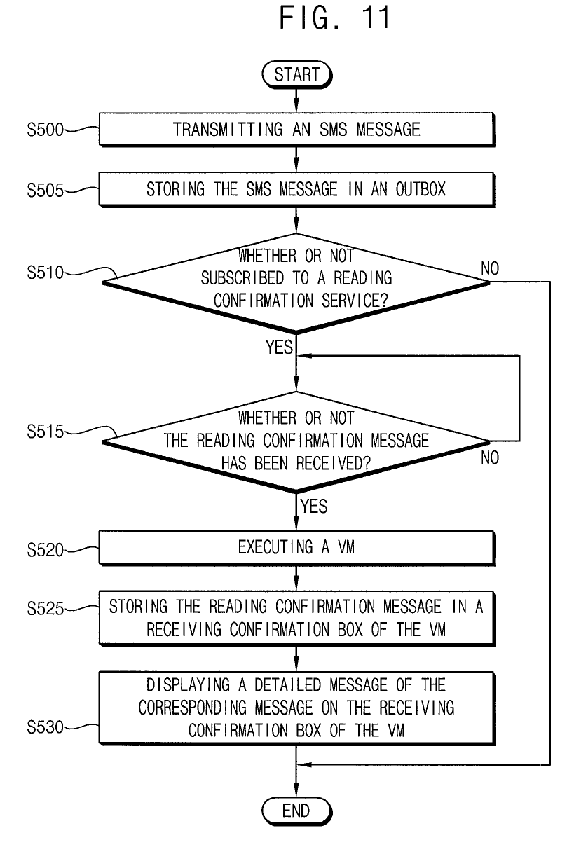

FIG. 9 is a flowchart schematically illustrating a method of a reading confirmation service of an SMS message according to a fourth embodiment of the present invention. FIG. 10 is an image showing examples of a mobile phone screen in accordance with a reading confirmation service of an SMS message as shown in FIG. 9. In FIG. 10, a dotted-line block is referred to as a receiving confirmation box of a VM. The receiving confirmation box is not displayed at a user side.

Referring to FIGS. 9 and 10, an SMS message that is composed through a transmitting mobile phone of a user is transmitted to a receiving mobile phone via a mobile communication network system (step S400).

Then, the transmitted SMS message is stored in an outbox of the transmitting mobile phone (step S405).

Then, the transmitting mobile phone 100 checks itself as to whether it is subscribed to the SMS message reading confirmation service by using a VM or not (step S410).

In step S410, the checking process is ended when it is not checked that the transmitting mobile phone is subscribed to the reading confirmation service, and it is checked whether the reading confirmation message is received when it is checked that the transmitting mobile phone is subscribed to the reading confirmation service (step S415). The reading confirmation message may be information provided from an SMSC server managing an SMS service of a mobile communication network system. The reading confirmation message may include information that the corresponding SMS message has been read by a user of the receiving mobile phone in addition to information that the SMS message has been normally received at the receiving mobile phone.

Then, a VM is executed (step S420).

Then, a reading confirmation message is stored in a receiving confirmation box included in the VM (step S425).

Then, an outbox of the transmitting mobile phone and the receiving confirmation box of the transmitting mobile phone are compared with each other by the VM (step S430).

Then, the transmitting mobile phone 100 checks whether a matching SMS message or not (step S435), the checking process is ended when the matching SMS message does not exist.

In step S435, when the matching SMS message exists, the matching text stored in the receiving confirmation box of the VM is removed (step S440).

Then, a matching SMS message that is stored in the outbox of the transmitting mobile phone is displayed as a text confirmation, that is, a reading confirmation (step S445). In FIG. 9, the step of displaying a reading confirmation is performed after the step of removing the text. Alternatively, the step of removing the text may be performed after the step of displaying the reading confirmation.

Then, it is checked whether or not a reading confirmation message is selected by a user (step S450). In step S450, the process is fed back to step S445 when the reading confirmation message is not selected by a user, and detailed information corresponding to the corresponding message is displayed on a display part when the reading confirmation message is selected by a user (step S455).

In FIG. 9, when it is checked that the reading confirmation message has been received in step S415, step S420 executing the VM is performed. In addition, the reading confirmation may be displayed on a display part of the transmitting mobile phone to immediately recognize a user. Here, the reading confirmation message displayed on the display part may include brief information or detailed information. For example, the brief information may include a phone number of the receiving side and a reading time. The detailed information may include a phone number of the receiving side, a reading time, contents of the message, etc., in addition to the brief information.

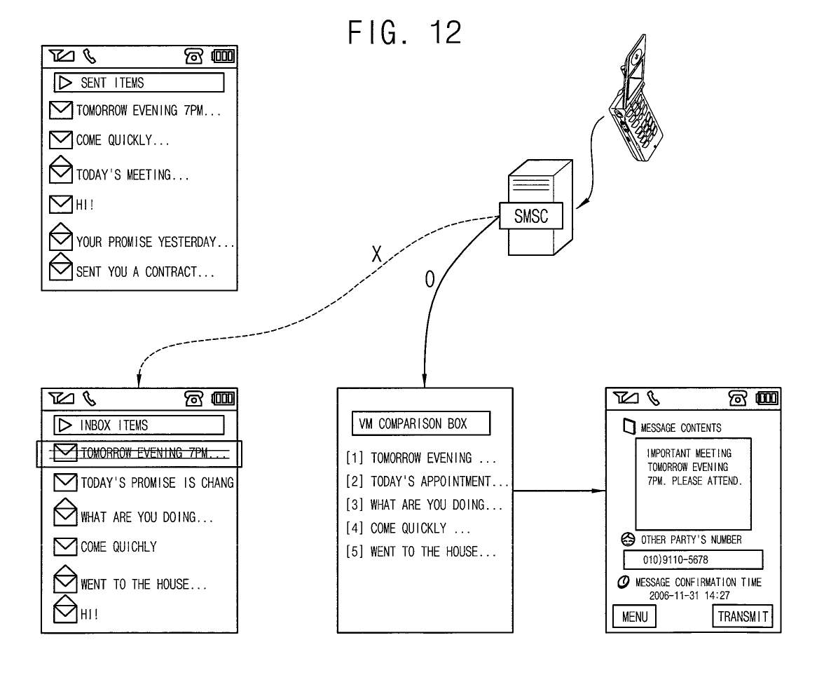

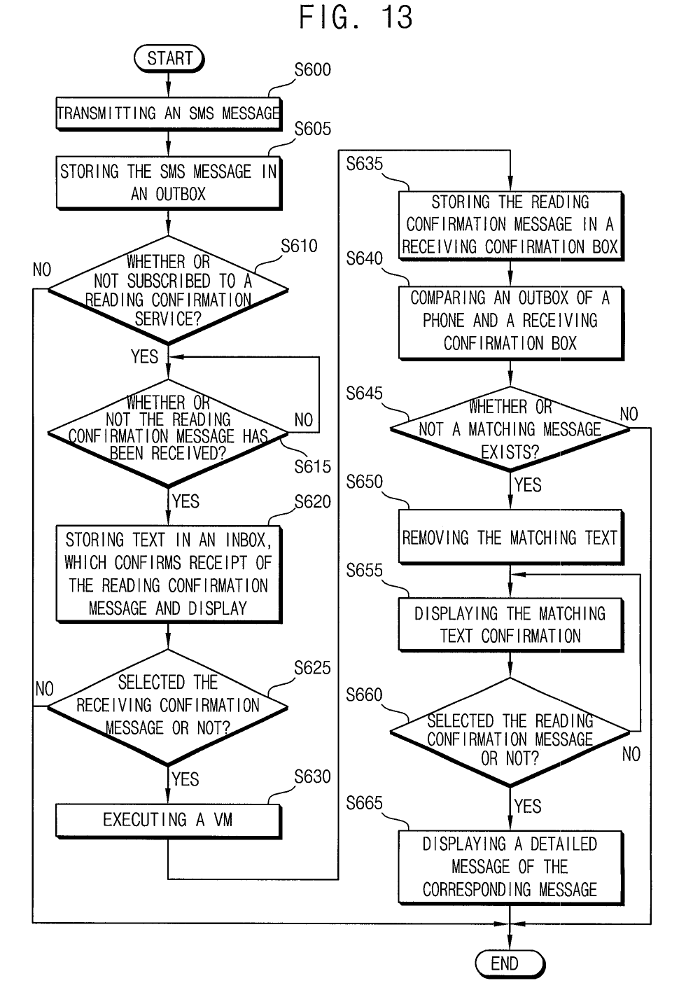

FIG. 11 is a flowchart schematically illustrating a method of a reading confirmation service of an SMS message according to a fifth embodiment of the present invention. FIG. 12 is an image showing examples of a mobile phone screen in accordance with a reading confirmation service of an SMS message as shown in FIG. 11. In FIG. 12, a dotted-line block is referred to as a receiving confirmation box of a VM. The receiving confirmation box is not displayed at a user side.

Referring to FIGS. 11 and 12, an SMS message that is composed through a transmitting mobile phone of a user is transmitted to a receiving mobile phone via a mobile communication network system (step S500).

Then, the transmitted SMS message is stored in an outbox of the transmitting mobile phone (step S505).

Then, the transmitting mobile phone 100 checks itself as to whether it is subscribed to the SMS message reading confirmation service by using a VM or not (step S510).

In step S510, the checking process is ended when it is not checked that the transmitting mobile phone is subscribed to the reading confirmation service, and it is checked whether the reading confirmation message is received when it is checked that the transmitting mobile phone is subscribed to the reading confirmation service (step S515). The reading confirmation message may include information that the corresponding SMS message has been read by a user of the receiving mobile phone in addition to information that the SMS message has been normally received at the receiving mobile phone.

Then, a VM is executed (step S520).

Then, a reading confirmation message is stored in a receiving confirmation box included in the VM (step S525).

Then, detailed message information of the corresponding message is displayed on a receiving confirmation box of the VM (step S530).

In FIG. 11, when it is checked that the reading confirmation message has been received in step S515, step S520 executing the VM is performed. In addition, the reading confirmation may be displayed on a display part of the transmitting mobile phone to immediately recognize a user. Here, the reading confirmation message displayed on the display part may include brief information or detailed information. For example, the brief information may include a phone number of the receiving side and a reading time. The detailed information may include a phone number of the receiving side, a reading time, contents of the message, etc., in addition to the brief information.

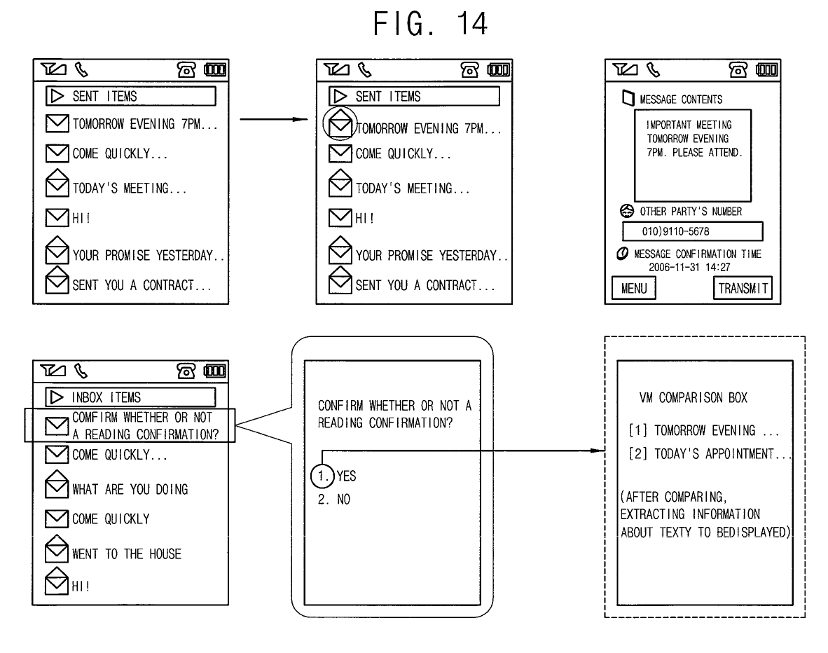

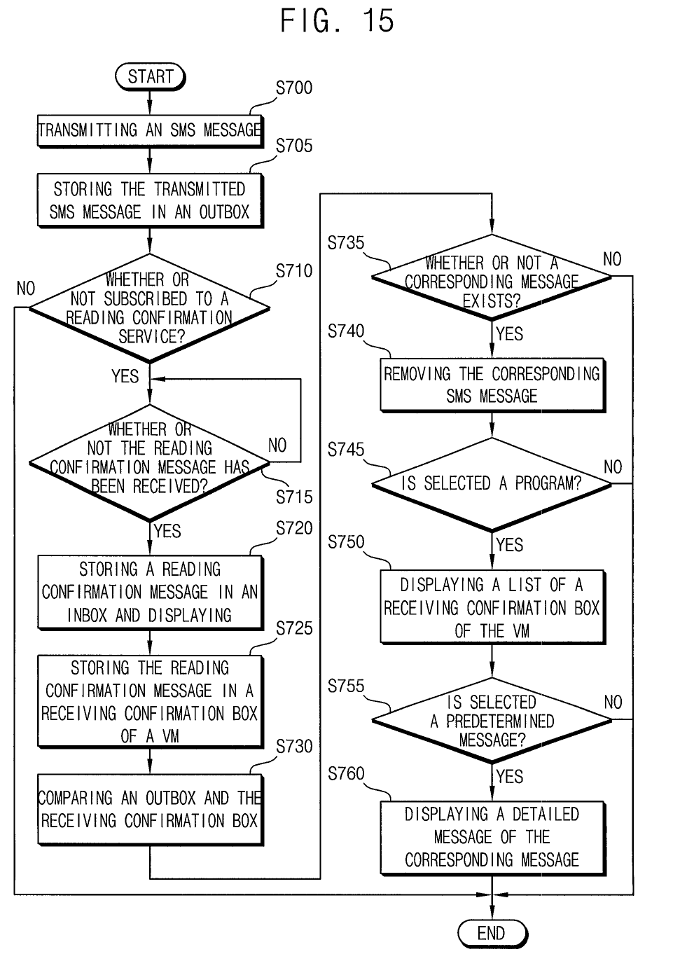

FIG. 13 is a flowchart schematically illustrating a method of a reading confirmation service of an SMS message according to a sixth embodiment of the present invention. FIG. 14 is an image showing examples of a mobile phone screen in accordance with a reading confirmation service of an SMS message as shown in FIG. 13. In FIG. 14, a dotted-line block is referred to as a receiving confirmation box of a VM. The receiving confirmation box is not displayed at a user side.

Referring to FIGS. 13 and 14, an SMS message that is composed through a transmitting mobile phone of a user is transmitted to a receiving mobile phone via a mobile communication network system (step S600).

Then, the transmitted SMS message is stored in an outbox of the transmitting mobile phone (step S605).

Then, the transmitting mobile phone 100 checks as to whether it is subscribed to the SMS message reading confirmation service by using a VM or not (step S610).

In step S610, the checking process is ended when it is not checked that the transmitting mobile phone is subscribed to the reading confirmation service, and it is checked whether the reading confirmation message is received when it is checked that the transmitting mobile phone is subscribed to the reading confirmation service (step S615). The reading confirmation message may include information that the corresponding SMS message has been read by a user of the receiving mobile phone in addition to information that the SMS message has been normally received at the receiving mobile phone.

Then, text, which confirms whether or not the reading confirmation message has been received, is stored in an inbox of the transmitting mobile phone, and then display the text on a display part (step S620). Here, the reading confirmation message displayed on the display part may include brief information or detailed information. For example, the brief information may include a phone number of the receiving side and a reading time. The detailed information may include a phone number of the receiving side, a reading time, contents of the message, etc., in addition to the brief information.

Then, it is checked whether or not a receiving or not confirmation message is selected by a user (step S625), and the checking process is ended when the receiving or not confirmation message is not selected by a user.

In step S625, when the receiving or not confirmation message is selected by a user, a VM is executed (step S630).

Then, a reading confirmation message is stored in a receiving confirmation box included in the VM (step S635).

Then, an outbox of a transmitting mobile phone and a receiving confirmation box included in the VM are compared with each other (step S640).

Then, it is checked whether a matching SMS message exists or not (step S645), and the checking process is ended when the matching SMS message does not exist.

In step S645, when the matching message exists, the matching text is removed from the receiving confirmation box included in the VM (step S650).

Then, the matching SMS message stored in the outbox of the transmitting mobile phone is displayed as a text confirmation, that is a reading confirmation (step S655). In FIG. 13, the step of displaying a reading confirmation is performed after the step of removing the text in the receiving confirmation box included in the VM. Alternatively, the step of removing the text in the receiving confirmation box included in the VM may be performed after the step of displaying the reading confirmation.

Then, it is checked whether or not a reading confirmation message is selected by a user (step S660). In step S660, the process is fed back to step S655 when the reading confirmation message is not selected by a user, and a detailed message corresponding to the corresponding message is displayed on a display part when the reading confirmation message is selected by a user (step S655).

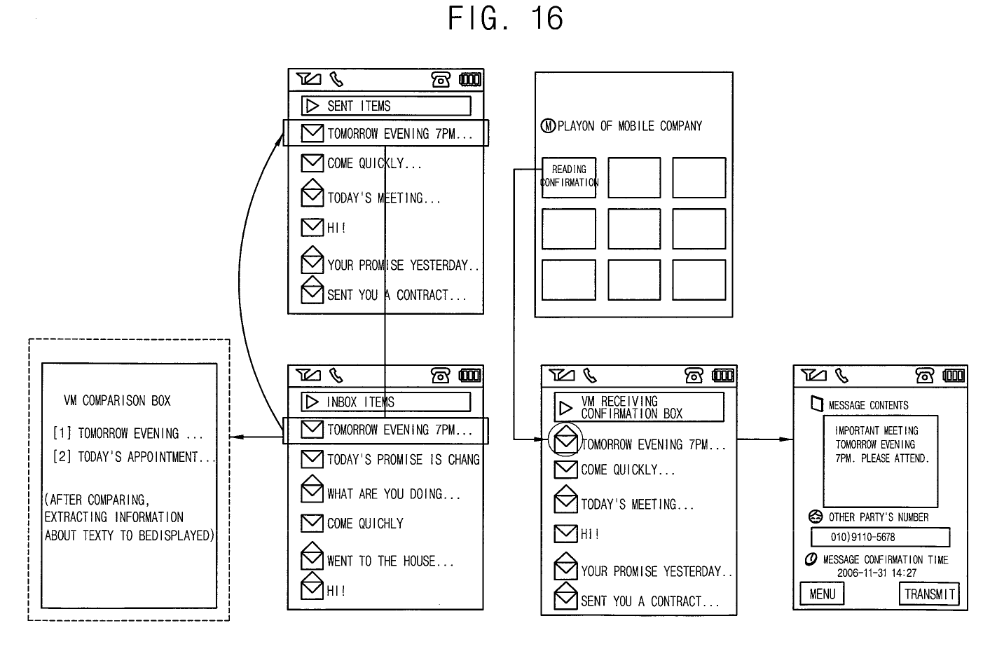

FIG. 15 is a flowchart schematically illustrating a method of a reading confirmation service of an SMS message according to a seventh embodiment of the present invention. FIG. 16 is an image showing examples of a mobile phone screen in accordance with a reading confirmation service of an SMS message as shown in FIG. 15. In FIG. 16, a dotted-line block is referred to as a receiving confirmation box of a VM. The receiving confirmation box is not displayed at a user side.

Referring to FIGS. 15 and 16, an SMS message that is composed through a transmitting mobile phone of a user is transmitted to a receiving mobile phone via a mobile communication network system (step S700).

Then, the transmitted SMS message is stored in an outbox of the transmitting mobile phone (step S705).

Then, the transmitting mobile phone 100 checks as to whether it is subscribed to the SMS message reading confirmation service by using a VM or not (step S710).

In step S710, the checking process is ended when it is not checked that the transmitting mobile phone is subscribed to the reading confirmation service, and it is checked whether the reading confirmation message is received when it is checked that the transmitting mobile phone is subscribed to the reading confirmation service (step S715). The reading confirmation message may include information that the corresponding SMS message has been read by a user of the receiving mobile phone in addition to information that the SMS message has been normally received at the receiving mobile phone.

Then, text, which confirms whether or not a reading confirmation message has been received, is stored in an inbox of the transmitting mobile phone, and then display the text on a display part (step S720). Here, the reading confirmation message displayed on the display part may include brief information or detailed information. For example, the brief information may include a phone number of the receiving side and a reading time. The detailed information may include a phone number of the receiving side, a reading time, contents of the message, etc., in addition to the brief information.

Then, a reading confirmation message is stored in a receiving confirmation box included in the VM (step S725).

Then, an outbox of a transmitting mobile phone and a receiving confirmation box included in the VM are compared with each other (step S730).

Then, it is checked whether a matching SMS message exists or not (step S735), and the checking process is ended when the matching SMS message does not exist.

In step S735, when the matching SMS message exists, the matching text is removed from the inbox of the transmitting mobile phone (step S740).

Then, it is checked whether or not a program, which confirms whether or not a reading confirmation message has been received, is selected by a user (step S745). In step S745, the checking process is ended when the program is not selected by a user.

In step S745, when the program is selected by a user, a list of text stored in the receiving confirmation box included in the VM is displayed on a display part (step S750).

Then, it is checked whether or not a predetermined message is selected (step S755), and the checking process is ended when the predetermined message is not selected by a user.

In step S755, when the predetermined message is selected by a user, a detailed message corresponding to the corresponding message is displayed on a display part when the predetermined message is selected by a user (step S760).

### INDUSTRIAL APPLICABILITY

According to the present invention, a mobile phone according to the present invention loads a program that performs a function of adding a message confirmation request to a transmitting message by a transmitting side, and a function of transmitting a message confirmation short message service (SMS) message to a transmitting mobile phone when the receiving user reads the SMS message received from the transmitting side. Therefore, substantial reading confirmation information of a receiving side for an SMS message is provided to a transmitting side, so that accuracy for a communication delivery between the transmitting side and the receiving side may be achieved.

Moreover, an SMS message stored in an outbox and a reading confirmation message stored in an inbox or a virtual machine (VM) are compared with each other to display the comparison result through symbols, text, images, etc., so as to recognize a user by using the VM of the terminal apparatus, so that usability of an SMS message may be provided to the SMS message transmitting side when a reading confirmation service of an SMS message is performed.

This invention has been described with reference to the example embodiments. It is evident, however, that many alternative modifications and variations will be apparent to those having skill in the art in light of the foregoing description. Accordingly, the present invention embraces all such alternative modifications and variations as falling within the spirit and scope of the appended claims.

1. A method for confirming a short message service (SMS) reading confirmation, which confirms whether or not the SMS message provided from a transmitting mobile phone has been read at a receiving mobile phone, the method comprising:
transmitting an SMS message and storing the transmitted SMS message in an outbox of the transmitting mobile phone;
when the transmitting mobile phone is subscribed to a reading confirmation service and the reading confirmation message has been received, displaying the received reading confirmation message on a display window of the transmitting mobile phone to compare with the SMS message stored in the outbox and the reading confirmation message; and
when the SMS message is in the outbox, displaying the corresponding SMS message as a reading confirmation.

2. A method for confirming an SMS reading confirmation, which confirms whether or not the SMS message provided from a transmitting mobile phone has been read at a receiving mobile phone, the method comprising:
transmitting an SMS message and storing the transmitted SMS message in an outbox of the transmitting mobile phone;
when the transmitting mobile phone is subscribed to a reading confirmation service and the reading confirmation message has been received, displaying the received reading confirmation message on a display window of the transmitting mobile phone, and storing the reading confirmation message in an inbox of the transmitting mobile phone;
comparing an SMS message stored in the outbox thereof and an SMS message stored in the inbox thereof by executing a virtual machine (VM);
when a matching SMS message is in the outbox, displaying the corresponding SMS message as a reading confirmation message; and
as the reading confirmation message has been selected by a user, displaying a detailed message of the corresponding message.

3. A method for confirming an SMS reading confirmation, which confirms whether or not the SMS message provided from a transmitting mobile phone has been read at a receiving mobile phone, the method comprising:
transmitting an SMS message and storing the transmitted SMS message in an outbox of the transmitting mobile phone;
when the transmitting mobile phone is subscribed to a reading confirmation service and the reading confirmation message has been received, displaying the received reading confirmation message on a display window of the transmitting mobile phone, and storing the reading confirmation message in a receiving confirmation box of the transmitting mobile phone;
comparing an SMS message stored in the outbox thereof and an SMS message stored in the receiving confirmation box included in a VM by executing the VM;
when a matching SMS message is in the outbox, displaying the corresponding SMS message as a reading confirmation message; and
as the reading confirmation message has been selected by a user, displaying a detailed message of the corresponding message.

4. A method for confirming an SMS reading confirmation, which confirms whether or not the SMS message provided from a transmitting mobile phone has been read at a receiving mobile phone, the method comprising:
transmitting an SMS message and storing the transmitted SMS message in an outbox of the transmitting mobile phone;
when the transmitting mobile phone is subscribed to a reading confirmation service and the reading confirmation message has been received, displaying the received reading confirmation message on a display window of the transmitting mobile phone, and storing text in an inbox of the transmitting mobile phone to display the text, wherein the text confirms whether or not the reading confirmation message has been received;
as the text is selected by a user, executing a VM to store a reading confirmation message in a receiving confirmation box of the VM;
comparing an SMS message stored in the outbox of the transmitting mobile phone and an SMS message stored in the receiving confirmation box of the VM through the VM;
when a matching SMS message is in the outbox, displaying the corresponding SMS message as a reading confirmation message; and
as the reading confirmation message has been selected by a user, displaying a detailed message of the corresponding message.

5. A method for confirming an SMS reading confirmation, which confirms whether or not the SMS message provided from a transmitting mobile phone has been read at a receiving mobile phone, the method comprising:
transmitting an SMS message and storing the transmitted SMS message in an outbox of the transmitting mobile phone;
when the transmitting mobile phone is subscribed to a reading confirmation service and the reading confirmation message has been received, displaying the received reading confirmation message on a display window of the transmitting mobile phone, and storing text in an inbox of the transmitting mobile phone to display the text, wherein the text confirms whether or not the reading confirmation message has been received;
storing a reading confirmation message in a receiving confirmation box of a VM, and comparing an SMS message stored in the outbox of the transmitting mobile phone and an SMS message stored in the receiving confirmation box of the VM through the VM;
when a matching SMS message is in the outbox, checking whether or not a program is selected by a user, wherein the program confirming whether or not a reading confirmation message has been received;
when the program for confirming whether or not the reading confirmation message has been received, displaying a list of a receiving confirmation box of the VM, and checking whether or not a predetermined message is selected by a user; and
when the predetermined message is selected by a user, displaying a detailed message of the corresponding message.

6. A method for confirming an SMS reading confirmation, which confirms whether or not the SMS message provided from a transmitting mobile phone has been read at a receiving mobile phone, the method comprising:
transmitting an SMS message and storing the transmitted SMS message in an outbox of the transmitting mobile phone;
when the transmitting mobile phone is subscribed to a reading confirmation service and the reading confirmation message has been received, displaying the received reading confirmation message on a display window of the transmitting mobile phone, and executing a VM included in the transmitting mobile phone to store the reading confirmation message in a receiving confirmation box of the VM; and
displaying a detailed message of the corresponding message stored in the receiving confirmation box of the VM.

7. The method of claim 1, wherein the reading confirmation message includes brief information.

8. The method of claim 1, wherein the reading confirmation message includes detailed information including the transmitted SMS message.

9. A reading confirmation terminal apparatus for confirming a reading of an SMS message by using an SMS message, the reading confirmation terminal apparatus comprising:
a display part;
a wireless circuit part setting a communication channel with a mobile communication network system; and
a control part transmitting an SMS message composed by a user, and storing the transmitted SMS message in an outbox thereof, when the transmitting mobile phone is subscribed to a reading confirmation service and the reading confirmation message has been received, comparing the SMS message stored in an outbox thereof and the reading confirmation message by using a VM to provide the display part with the comparison result so as to recognize a user,
when the reading confirmation message has been received, wherein the control part displays the reading confirmation message on the display part.

10. The reading confirmation terminal apparatus of claim 9, wherein the reading confirmation message includes brief information.

11. The reading confirmation terminal apparatus of claim 9, wherein the reading confirmation message includes detailed information including the transmitted SMS message.
